(19) United States
(12) Patent Application Publication
(10) Pub. No.: US 2026/0010882 A1
(43) Pub. Date: Jan. 8, 2026

(54) DIGITAL ACCOUNT MANAGEMENT HAVING AGGREGATED ACCOUNT DISPLAY

(71) Applicant: Truist Bank, Charlotte, NC (US)

(72) Inventors: Kristen Martin, Charlotte, NC (US); Candice Roberts, Charlotte, NC (US); Erin Nash, Charlotte, NC (US); Jennifer Herring, Raleigh, NC (US)

(73) Assignee: Truist Bank, Charlotte, NC (US)

(21) Appl. No.: 19/326,121

(22) Filed: Sep. 11, 2025

Related U.S. Application Data
(63) Continuation-in-part of application No. 18/168,072, filed on Feb. 13, 2023, now abandoned.

(51) Int. Cl. G06Q 20/10; G06Q 20/14; G06Q 20/40

(52) U.S. Cl. CPC G06Q 20/10; G06Q 20/14; G06Q 20/403; G06Q 20/409

(57) ABSTRACT

The present disclosure relates to technology for aggregating a plurality of internal user account data and external user account data for visual display on a user interface (UI) of a client device, and facilitating transactions (e.g., fund transfers, bill payment) between internal user accounts and external user accounts.

### CROSS-REFERENCE TO RELATED APPLICATIONS

The present application is a continuation-in-part of U.S. patent application Ser. No. 18/168,072 (filed on Feb. 13, 2023), the contents of which is hereby incorporated by reference in its complete entirety.

### TECHNICAL FIELD

The present disclosure relates to technology for aggregating a plurality of internal user account data and external user account data from heterogeneous account sources for visual display on a user interface (UI) of a client device, and facilitating transactions (e.g., fund transfers, bill payment) between internal user accounts and external user accounts.

### BACKGROUND

Current systems often suffer from limitations in data security, adaptability, and real-time responsiveness, particularly when managing heterogeneous account structures across different platforms. In the context of digital bill pay platforms, users are typically required to navigate separate interfaces for each enterprise or account type to execute payments. While some systems offer the ability to pay payees using funds from multiple accounts, they generally do not provide a fully integrated solution that allows for seamless inter-account transfers between internal and external accounts within a single user experience. This fragmentation can lead to inefficiencies, increased user effort, and potential errors in transaction execution.

Moreover, the lack of dynamic updating mechanisms in these platforms can result in outdated or incomplete account/asset information being presented to the user. Current systems also exhibit shortcomings in their ability to dynamically calculate and display net worth based on real-time data from multiple accounts. While some applications offer static or semi-static net worth summaries, they often fail to incorporate real-time changes in account balances or transaction statuses, thereby reducing the accuracy and utility of such metrics. Additionally, the presentation of user asset/account data is frequently limited to basic visualizations without the inclusion of interactive or user-engageable widgets that could enhance decision-making and user interaction. These limitations highlight a need for improved methodologies in the aggregation, management, and presentation of user account data across internal and external account structures. The existing approaches, while functional in certain contexts, are not sufficiently robust to address the complexities of modern account ecosystems where users interact with multiple institutions and require up-to-date, secure, and intuitive access to their account information.

### SUMMARY

The server computing system in accordance with the present disclosure includes a host enterprise mobile application engine with one or more processors and a non-transitory memory. The memory includes executable instructions that, when executed by the processors, perform operations including capturing client device authentication credentials from an authenticated client device of a user. The system accesses, as a proxy for the client device using the captured credentials, a third-party enterprise mobile application or web application. It transmits an API call to third-party enterprise servers to extract external user account data, which is then aggregated with internal user account data maintained by the enterprise. The system generates an adaptive GUI on the client device's UI to display the aggregated data.

Additional features include assigning user-engageable widgets to the internal and external account data, deploying a trained ML model to classify widgets based on account type, rearranging widgets based on classification, enabling inter-account funds transfers between internal and external accounts, verifying sufficient funds for transfers, dynamically updating aggregated data post-transfer, calculating the user's current net worth, and generating a second adaptive GUI to display the calculated net worth. The system also includes generating a random unique identifier for the client device as a client device ID, automatically generating an entitlement data structure associating the ID with entitlement data, verifying the identity of the client device via the entitlement data structure, assigning entitlement rules based on access permissions, automatically deploying entitlement rules and transmitting API calls, and receiving access permission during launching of an enterprise mobile application.

In accordance with one or more embodiments set forth, illustrated, and described herein, a server computing system comprises one or more of the following: a host enterprise mobile application engine having one or more processors and a non-transitory memory coupled to the one or more processors, the non-transitory memory including a set of executable instructions of computer-executable program code, which when executed by the one or more processors, cause the one or more processors to perform operations including one or more of the following: capturing client device authentication credentials from an authenticated client device of a user, accessing, as a proxy for the authenticated client device using the captured client device authentication credentials, a third-party enterprise mobile application or third-party enterprise web application, transmitting an application programming interface (API) call to a third-party enterprise servers to extract external user account data from third-party enterprise mobile applications or the third-party enterprise web applications, the API call including an identify token, the external user account data associated with one or more external user accounts maintained by one or more third-party enterprises, aggregating the external user account data with internal user account data associated with one or more internal user accounts maintained by the enterprise as aggregated data, and generating an adaptive graphical user interface (GUI) on a user interface (UI) of the authenticated client device to display the aggregated data.

In accordance with one or more embodiments set forth, illustrated, and described herein, a computer program product comprising at least one non-transitory computer readable medium having with a set of executable instructions of computer-executable program code, which when executed by one or more processors of a server computing system, causes the server computing system to perform operations including one or more of the following: capturing client device authentication credentials from an authenticated client device of a user, accessing, as a proxy for the authenticated client device using the captured client device authentication credentials, a third-party enterprise mobile application or third-party enterprise web application, transmitting an application programming interface (API) call to a third-party enterprise servers to extract external user account data from the third-party enterprise mobile applications or the third-party enterprise web applications, the API call including an identify token, the external user account data associated with one or more external user accounts maintained by one or more third-party enterprises, aggregating the external user account data with internal user account data associated with one or more internal user accounts maintained by the enterprise as aggregated data, and generating an adaptive graphical user interface (GUI) on a user interface (UI) of the authenticated client device to display the aggregated data.

In accordance with one or more embodiments set forth, illustrated, and described herein, a method implemented by a server computing system comprises one or more of the following: capturing client device authentication credentials from an authenticated client device of a user, accessing, as a proxy for the authenticated client device using the captured client device authentication credentials, a third-party enterprise mobile application or third-party enterprise web application, transmitting an application programming interface (API) call to a third-party enterprise servers to extract external user account data from the third-party enterprise mobile application or the third-party enterprise web application, the API call including an identify token, the external user account data associated with one or more external user accounts maintained by one or more third-party enterprises, aggregating the external user account data with internal user account data associated with one or more internal user accounts maintained by the enterprise as aggregated data, and generating an adaptive graphical user interface (GUI) on a user interface (UI) of the authenticated client device to display the aggregated data.

In accordance with the one or more embodiments, the set of executable instructions, which when executed by the one or more processors, causes the one or more processors to perform operations further including assigning user-engageable widgets to the internal user account data and the external user account data.

In accordance with the one or more embodiments, the set of executable instructions, which when executed by the one or more processors, causes the one or more processors to perform operations further including causing the adaptative GUI to display the user-engageable widgets in a random arrangement.

In accordance with the one or more embodiments, the set of executable instructions, which when executed by the one or more processors, causes the one or more processors to perform operations further including deploying a trained ML model to classify the user-engageable widgets based on account type.

In accordance with the one or more embodiments, the set of executable instructions, which when executed by the one or more processors, causes the one or more processors to perform operations further including causing the adaptative GUI to rearrange the randomly displayed user-engageable widgets based on the assigned classification.

In accordance with the one or more embodiments, the set of executable instructions, which when executed by the one or more processors, causes the one or more processors to perform operations further including causing the adaptative GUI to display the user-engageable widgets based on the assigned classification.

In accordance with the one or more embodiments, the set of executable instructions, which when executed by the one or more processors, causes the one or more processors to perform operations further including receiving, from the authenticated client device, a user request to conduct an inter-account funds transfer between the displayed one or more internal user accounts as a source account and the displayed one or more external user accounts as a destination account.

In accordance with the one or more embodiments, the set of executable instructions, which when executed by the one or more processors, causes the one or more processors to perform operations further including verifying that the source account has a sufficient amount of funds to cover a monetary amount associated with the inter-account funds transfer.

In accordance with the one or more embodiments, the set of executable instructions, which when executed by the one or more processors, causes the one or more processors to perform operations further including executing the inter-account funds transfer when it is determined that the source account has a sufficient amount of funds to cover the monetary amount.

In accordance with the one or more embodiments, the set of executable instructions, which when executed by the one or more processors, causes the one or more processors to perform operations further including dynamically updating the aggregated data in response to executing the inter-account funds transfer.

In accordance with the one or more embodiments, the set of executable instructions, which when executed by the one or more processors, causes the one or more processors to perform operations further including calculating a current net worth of the user based on the aggregated data.

In accordance with the one or more embodiments, the set of executable instructions, which when executed by the one or more processors, causes the one or more processors to perform operations further including generating a second adaptive GUI for on the UI of the authenticated client device to display the calculated current net worth.

In accordance with the one or more embodiments, the set of executable instructions, which when executed by the one or more processors, causes the one or more processors to perform operations further including generating, by the mobile application engine, a random unique identifier associated with the authenticated client device as a client device ID.

In accordance with the one or more embodiments, the set of instructions, which when executed by the one or more processors, cause the one or more processors to perform operations further including automatically generating an entitlement data structure associating the client device ID with client device entitlement data.

In accordance with the one or more embodiments, the set of instructions, which when executed by the one or more processors, cause the one or more processors to perform operations further including verifying the identity of the authenticated registered client device by mapping, via the entitlement data structure, the unauthenticated registered client device to the client device ID.

In accordance with the one or more embodiments, the set of executable instructions, which when executed by the one or more processors, causes the one or more processors to perform operations further including assigning an entitlement rule associated with the authenticated registered client device based on the client device entitlement data that includes the access permission.

In accordance with the one or more embodiments, the set of executable instructions, which when executed by the one or more processors, causes the one or more processors to perform operations further including automatically deploying the entitlement rule and transmitting the application programming interface (API) call.

In accordance with the one or more embodiments, the set of executable instructions, which when executed by the one or more processors, causes the one or more processors to perform operations further including receiving, from the authenticated client device during a launching of an enterprise mobile application by the authenticated registered client device, access permission to the external user account data.

In accordance with the one or more embodiments, the set of instructions, which when executed by the one or more processors, cause the one or more processors to perform operations further including detecting an overlapping condition in which the displayed user-engageable widgets overlaps displayed visual content on the UI of the authenticated client device.

In accordance with the one or more embodiments, the set of instructions, which when executed by the one or more processors, cause the one or more processors to perform operations further including automatically relocating, in response to the detection, the displayed user-engageable widgets to an alternative region of the UI of the authenticated registered client device that does not present an overlapping condition.

### DRAWINGS

The various advantages of the exemplary embodiments will become apparent to one skilled in the art by reading the following specification and appended claims, and by referencing the following drawings, in which:

FIG. 1 illustrates a communication environment in accordance with one or more embodiments set forth and described herein.

FIG. 2 illustrates a block diagram of the client device of FIG. 1 comprising a mobile device.

FIG. 3 illustrates a block diagram of the client device of FIG. 1 comprising a personal computing device.

FIG. 4 illustrates a block diagram of the one or more servers of the server computing system of FIG. 1.

FIG. 5 illustrates a UI of the client device of FIG. 1.

FIGS. 6A and 6B respectively illustrate a GUI for visual display on the UI of FIG. 5.

FIGS. 7 through 10 respectively illustrate GUIs for visual display on the UI of FIG. 5.

FIGS. 11 through 15 respectively illustrate exemplary computer-implemented methods, in accordance with one or more embodiments set forth and described herein.

FIG. 16 illustrates a GUI for capturing data associated with payees from a third-party bill pay digital platform into a host bill pay digital platform, in accordance with one or more embodiments as set forth and described herein.

FIG. 17 illustrates a block diagram of a workflow configuration for data aggregation, in accordance with one or more embodiments as set forth and described herein

### DESCRIPTION

Herein below are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “dynamically” relates to events or actions that can be caused, triggered, or otherwise occur without human intervention.

As used herein, “machine learning” relates to an application of AI that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, an enterprise is a business entity (e.g., bank, credit union, credit card network, trust company, brokerage company, insurance company, etc.) that provides products and services to its clients/customers.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where a plurality of hardware modules exist contemporaneously, communications may be achieved through signal transmission (e.g., over appropriate circuits and buses) between or among two or more of the hardware modules. In embodiments in which a plurality of hardware modules is configured or instantiated at different times, communications between such hardware modules may be achieved, for example, through the storage and retrieval of information in memory structures to which the plurality of hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of executable instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

As used herein, “widget” relates to electronic visual tiles that may be added to a home screen dashboard that are bigger than a regular application widget and have additional functionality. The widget may include shortcuts directly to popular features within a web application or mobile application.

The present disclosure includes a system that introduces a robust and secure method for aggregating and managing both internal and external user account data through a centralized, adaptive GUI. Unlike conventional systems that rely on static or limited integration methods, this approach employs a server-based architecture that captures and utilizes client device authentication credentials to act as a proxy for accessing third-party web applications and mobile applications. This enables real-time data retrieval and aggregation without requiring manual intervention or exposing sensitive credentials to the user interface layer. The use of a trained machine learning model to classify and dynamically rearrange user-engageable widgets based on account type enhances usability and personalization, offering a more intuitive and responsive experience compared to static or manually configured interfaces found in existing platforms.

Furthermore, the system supports seamless inter-account transactions between internal and external accounts by verifying fund availability and dynamically updating aggregated data post-transaction, ensuring data consistency and accuracy without requiring full page reloads or user-initiated refreshes. The inclusion of an automated entitlement management framework, which generates a unique client device identifier and associates it with access permissions, provides an additional layer of security and control over data access and transaction execution. This entitlement-based approach allows for fine-grained access control and rule deployment, improving both security and scalability in multi-user enterprise environments. These features collectively address limitations in current account management systems by offering a more integrated, secure, and adaptive solution for handling diverse account data sources.

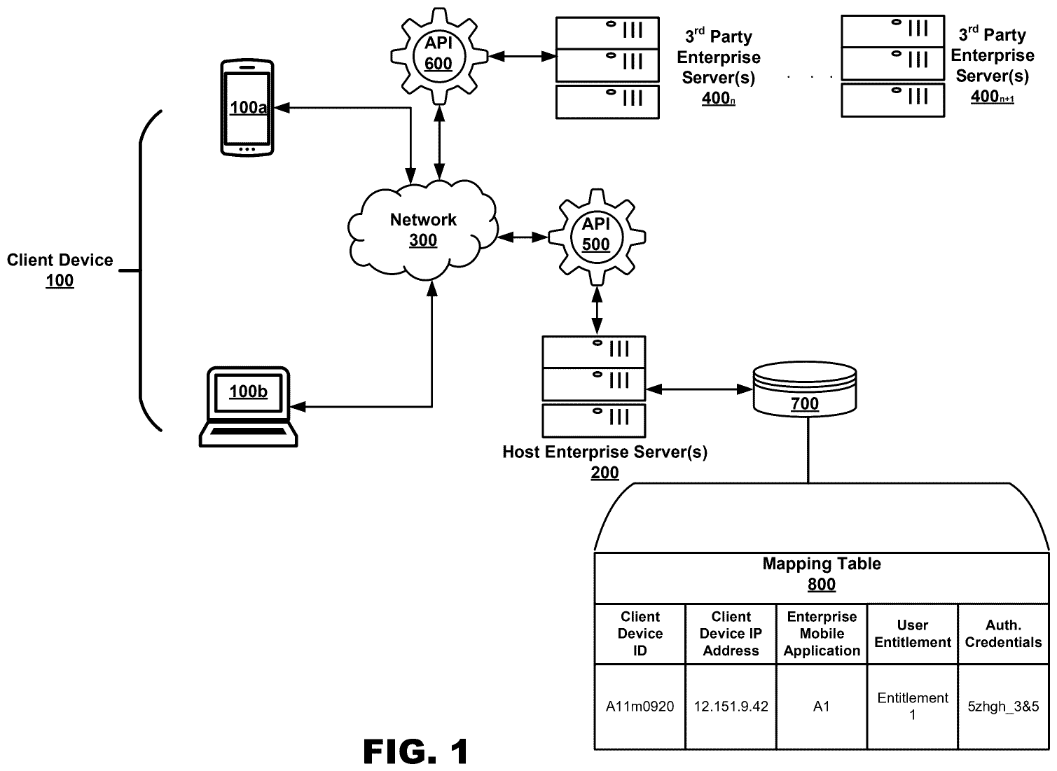

Turning to the figures, in which FIG. 1 illustrates a communication environment in which an authenticated client device 100 communicates with an enterprise and a third-party over a communications network. The client device 100 operates in the communication environment to facilitate user access to and user management of one or more user accounts maintained by the enterprise via one or more host enterprise servers 200. The communication environment includes the client device 100, the one or more enterprise servers 200, one or more third-party enterprise servers 400ₙ, 400ₙ₊₁, an application programming interface (API) 500 for communications between the one or more enterprise servers 200 and the client device 100 via the host enterprise mobile application residing in a host enterprise mobile application engine 222, an account aggregation API 600 for communications between the one or more enterprise servers 200 and the one or more third-party enterprise servers 400ₙ, 400ₙ₊₁ via a third-party enterprise mobile application, and a storage location such as one or more databases 800.

In accordance with one or more embodiments, a client device 100 of the user can, via the communications network 300, access data associated with the one or more user accounts that reside at the one or more host enterprise servers 200. The one or more host enterprise servers 200 operate and maintain a graphical user interface (GUI) (e.g., a host enterprise website, or a host enterprise mobile software application) which provides information and functionality for the user account(s) that are maintained by the host enterprise.

In accordance with one or more embodiments, the client device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 100 comprising any form of electronic device that optimizes the performance and functionality of the one or more embodiments in a manner that falls within the spirit and scope of the principles of this disclosure.

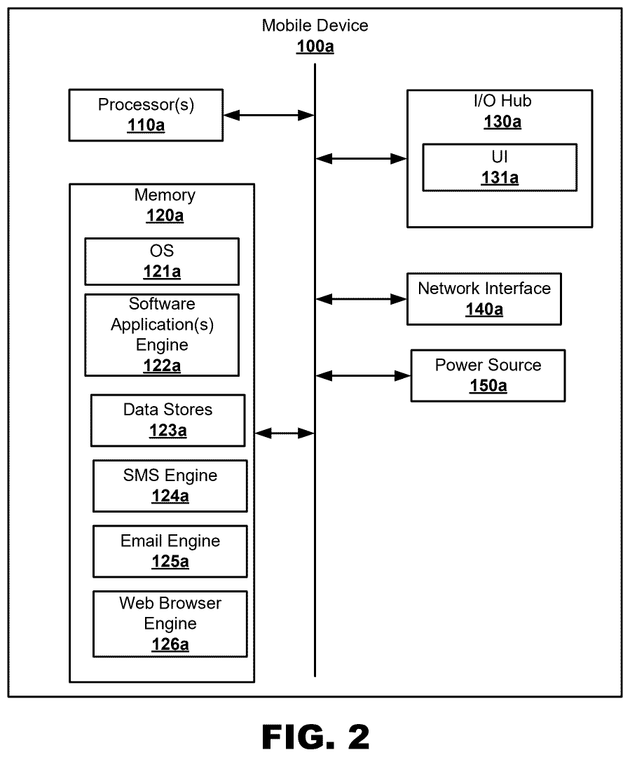

In the illustrated example embodiment of FIG. 2, the client device 100 comprises a mobile device 100a. Some of the possible operational elements of the mobile device 100a are illustrated in FIG. 2 and will now be described herein. It will be understood that it is not necessary for the mobile device 100a to have all the elements illustrated in FIG. 2. For example, the mobile device 100a may have any combination of the various elements illustrated in FIG. 2. Moreover, the mobile device 100a may have additional elements to those illustrated in FIG. 2.

The mobile device 100a includes one or more processors 110a, a non-transitory memory 120a operatively coupled to the one or more processors 110a, an I/O hub 130a, a network interface 140a, and a power source 150a.

The memory 120a comprises a set of executable instructions of computer-executable program code. The set of executable instructions are executable by the one or more processors 110a to cause the one or more processors 110a to execute an operating system 121a and one or more software applications of a software application engine 122a that reside in the memory 120a. The one or more software applications residing in the memory 120a includes, but is not limited to, a host enterprise mobile application which facilitates user access to and management of the one or more user accounts. The host enterprise mobile application facilitates establishment of a secure connection between the mobile device 100a and the one or more host enterprise servers 200.

The memory 120a also includes one or more data stores 123a that are operable to store one or more types of data. The mobile device 100a may include one or more interfaces that facilitate one or more systems or modules thereof to transform, manage, retrieve, modify, add, or delete, the data residing in the data stores 123a. The one or more data stores 123a may comprise volatile and/or non-volatile memory. Examples of suitable data stores 123a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 123a may be a component of the one or more processors 110a, or alternatively, may be operatively connected to the one or more processors 110a for use thereby. As set forth, described, and/or illustrated herein, “operatively connected” may include direct or indirect connections, including connections without direct physical contact.

The memory 120a also includes an SMS module 124a operable to facilitate user transmission and receipt of text messages via the mobile device 100a though the network 300. In one example embodiment, a user may receive text messages from the enterprise that are associated with the user access and the user management of the one or more user accounts. An email module 125a is operable to facilitate user transmission and receipt of email messages via the mobile device 100a through the network 300. In one example embodiment, a user may receive email messages from the enterprise that are associated with the user access and the user management of the one or more user accounts.

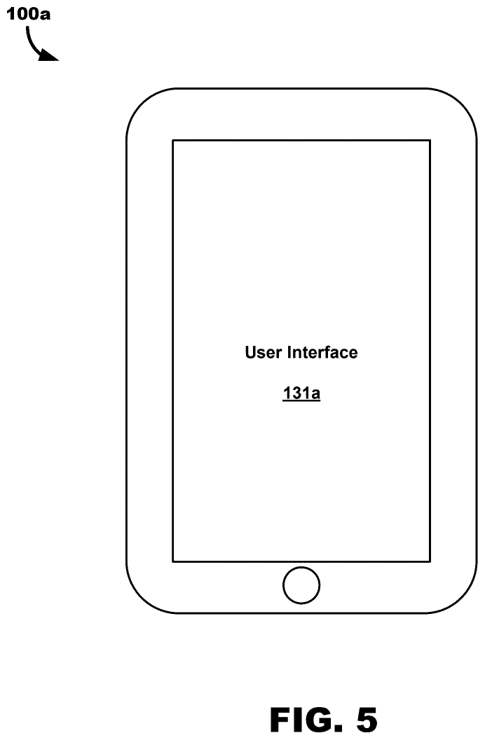

In accordance with one or more embodiments, the mobile device 100a includes an I/O hub 130a operatively connected to other systems and subsystems of the mobile device 100a. The I/O system 130a may include one or more of an input interface, an output interface, and a network controller to facilitate communications between the client device 100 and the server 200. The input interface and the output interface may be integrated as a single, unitary UI131a (FIG. 5), or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a to execute instructions. The input interface may comprise a UI, a GUI, such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The mobile device 100a includes a network interface 140a operable to facilitate connection to the network 300. The mobile device 100a also includes power source 150a that comprises a wired powered source, a wireless power source, a replaceable battery source, or a rechargeable battery source.

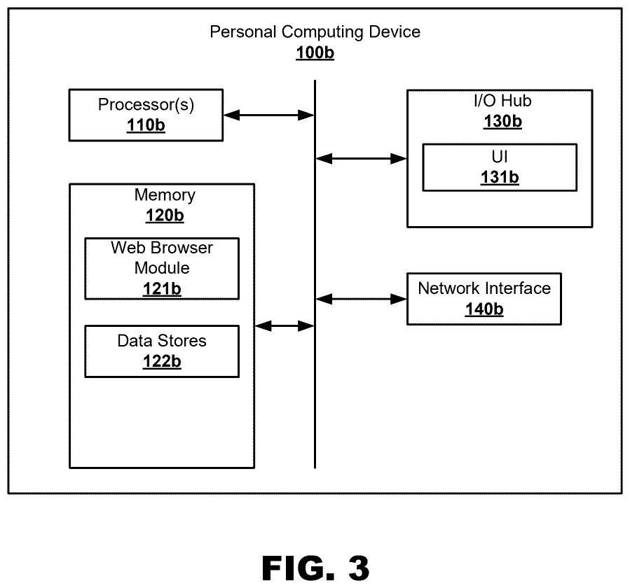

In the illustrated example embodiment of FIG. 3, the client device 100 comprises a personal computing device 100b. Some of the possible operational elements of the personal computing device 100b are illustrated in FIG. 3 and will now be described herein. It will be understood that it is not necessary for the personal computing device 100b to have all the elements illustrated in FIG. 3. For example, the personal computing device 100b may have any combination of the various elements illustrated in FIG. 3. Moreover, the personal computing device 100b may have additional elements to those illustrated in FIG. 3.

The personal computing device 100b includes one or more processors 110b, a non-transitory memory 120b operatively coupled to the one or more processors 110a, an I/O hub 130b, and a network interface 140b.

The memory 120b comprises a set of executable instructions of computer-executable program code. The set of executable instructions are executable by the one or more processors 110b to cause the one or more processors 110b to control the web browser module 121b in a manner that facilitates user access to a web browser having one or more websites associated with the enterprise through the network 300.

The memory 120b also includes one or more data stores 122b that are operable to store one or more types of data. The personal computing device 100b may include one or more interfaces that facilitate one or more systems or modules thereof to transform, manage, retrieve, modify, add, or delete, the data residing in the data stores 123b. The one or more data stores 123b may comprise volatile and/or non-volatile memory. Examples of suitable data stores 123b include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 123b may be a component of the one or more processors 110b, or alternatively, may be operatively connected to the one or more processors 110b for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 110a, 110b may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110a, 110b may comprise at least one hardware circuit (e.g., an integrated circuit) operable to carry out instructions contained in program code. In embodiments in which there is a plurality of processors, such processors may work independently from each other, or one or more processors may work in combination with each other.

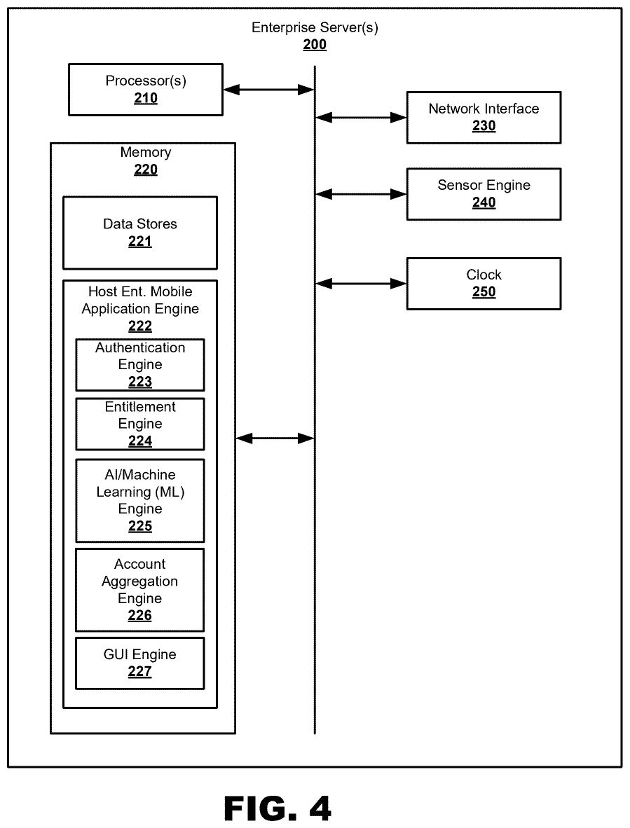

As illustrated in FIG. 4, the one or more host enterprise servers 200 includes one or more processors 210, a non-transitory memory 220 operatively coupled to the one or more processors 210, a network interface 230, a sensor engine 240, and a clock 250 that is operable to perform time/temporal measurements. Some of the possible operational elements of each server in the one or more host enterprise servers 200 are illustrated in FIG. 4 and will now be described herein. It will be understood that it is not necessary for each server in the one or more host enterprise servers 200 to have all the elements illustrated in FIG. 4. For example, each server in the one or more host enterprise servers 200 may have any combination of the various elements illustrated in FIG. 4. Moreover, each enterprise server in the one or more host enterprise servers 200 may have additional elements to those illustrated in FIG. 4.

In accordance with one or more embodiments set forth, the one or more processors 210 may comprise artificial intelligence (AI) processors, machine learning (ML) processors, and combinations thereof that are operable to perform or otherwise implement accelerated processing of the one or more methods set forth and described herein.

In accordance with one or more embodiments set forth, described, and/or illustrated herein, the one or more host enterprise servers 200 may be controlled by an enterprise system manager (or policy manager).

The memory 220 includes one or more data stores 221 that are operable to store one or more types of data, including but not limited to, user account data and user authentication data. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The memory 220 comprises a set of executable instructions of computer-executable program code. The set of executable instructions are executable by the one or more processors 210 in manner that facilitates control of a plurality of processor-implemented engines that includes a mobile application engine 222, an authentication engine 223, an entitlement engine 224, an AI/ML engine 225, an account aggregation engine 226, and a GUI engine 227 that reside in the memory 220. In accordance with one or more embodiments set forth, described, and/or illustrated herein, the one or more host enterprise servers 200 may individually or collectively execute the instructions to perform or otherwise implement any one or more of the methodologies set forth, described, and illustrated herein. The memory 220 may store a lookup table or mapping table that associates the client device 100 to the assigned client device ID and any entitlements associated with the user account.

The memory 220 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by the one or more host enterprise servers 200, such that the instructions, when executed by the one or more processors 210, cause the one or more processors 210 to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The computer-executable program code may instruct the one or more processors 210 to execute certain logic, data-processing, and data-storing functions of the one or more host enterprise servers 200, in addition to certain communication functions of the one or more host enterprise servers 200. The mobile application engine 222, via the mobile application API 500, is operable to communicate with the client device 100 (having launched the host enterprise mobile application) in a manner which facilitates user access to the one or more user accounts in addition to user management of the one or more user accounts based on successful client device authentication. The data exchanged between the client device 100 and the one or more host enterprise servers 200 may be encrypted during communications therebetween using a data encryption process. The computer-executable program code may instruct the one or more processors 210 to conduct the data encryption process by performing operations that include: deploying a key generation algorithm that generates a symmetric encryption/decryption key; and deploying an encryption algorithm using the encryption key to transform the data to an unreadable, encrypted format. The data may be decrypted through a data decryption process that includes deploying a decryption algorithm using the decryption key to transform the encrypted data to its original, readable format.

The authentication engine 223 is operable to verify the identity of the client device 100 by implementing one or more authentication protocols that map client device authentication credentials to stored authentication credentials. The authentication protocols may include multi-factor authentication, biometric authentication, password-based authentication, token-based biometric authentication, etc. The authentication engine 223 is operable to deploy the data encryption process to encrypt the authentication credentials in order to protect the user's sensitive data. This includes authentication credentials that facilitate user access to internal user account data maintained by the one or more host enterprise servers 200 and user third-party authentication credentials that facilitate access by the one or more host enterprise servers 200 to external user account data maintained by the one or more third-party enterprise servers 400n, 400n+1. The authentication engine 223 is operable to then securely store the encrypted authentication credentials at a storage location (e.g., databases 700). Upon the capture of authentication credentials by the one or more host enterprise servers 200, the authentication engine 223 is operable to verify the validity of the authentication credentials by mapping the captured authentication credentials to the stored encrypted authentication credentials. Should the captured authentication credentials match the stored encrypted authentication credentials, the identity of the user and/or the client device 100 is confirmed.

The entitlement engine 224 is operable to acquire user entitlement data, and store the user entitlement data at a data storage location (e.g., data stores 221 and/or one or more databases 800). The entitlement engine 224 includes, inter alia, one or more entitlement or permission rules that are associated with the user entitlement data. The user entitlement data includes, inter alia: (i) user authorization (to be implemented as rules) to have the one or more host enterprise servers 200 serve as a proxy for the user to communicate with the third-party enterprise servers by deploying the user third-party authentication credentials to gain access to confidential or sensitive user asset data (e.g., external user account data) that is maintained by the one or more third-party enterprises, and (ii) user authorization to have the one or more host enterprise servers 200 selectively aggregate and display the confidential or sensitive user asset data (e.g., internal user account data and external user account data) on a single UI of an authenticated client device 100. Such confidential or sensitive user asset data may include, but is not limited to, internal user account data maintained by the host enterprise and external user account data maintained by the one or more third-party enterprises.

The AI/ML engine 225 may comprise one or more AI/ML processors operable to perform or otherwise implement accelerated processing of the one or more methods set forth and described herein. The one or more AI/ML processors are operable to perform operations involving machine learning (ML) by generating one or more trained ML models. The AI/ML engine 225 include one or more ML algorithms to train one or more machine learning models as a trained ML model based on data and/or information residing in the memory 220 and/or one or more storage locations (e.g., one or more databases 800). The ML algorithms may include one or more of a linear regression algorithm, a logical regression algorithm, or a combination of different algorithms. A neural network may also be used to train the system based on the received data. The AI/ML engine 225 may analyze the received data and/or information, and transform the data and/or information in a manner which provides enhanced communication between the client device 100 and the one or more host enterprise servers 200, while also enhancing user access and user management of the one or more user accounts. The data and/or information may also be up-linked to other systems and modules in the one or more host enterprise servers 200 for further processing to discover additional information that may be used to enhance the understanding of the information.

The account aggregation engine 226 is operable to perform several tasks with respect to the aggregation of confidential or sensitive user asset data, including the internal user account data and the external user account data.

The one or more third-party enterprise servers 400ₙ, 400ₙ₊₁ are configured to make, via the third-party enterprise mobile application, an API call to the account aggregation API 600. The API call may utilize a uniform resource identifier (URI), such as a Uniform Resource Locator (URL) or Uniform Resource Name (URN) to make the necessary identification, incorporate an application layer protocol indicating the desired action to be performed by the account aggregation API 600 (e.g., the authentication credentials to be extracted), incorporate a request header, and provide an API key or access token to be used by the account aggregation API 600 to authenticate the API call. The account aggregation API 600 may then securely transmit an API response to the one or more third-party enterprise servers 400ₙ, 400ₙ₊₁ that includes the encrypted authentication credentials in the form of a data structure that facilitates auto-population into authentication input fields for the third-party enterprise mobile application.

Upon acceptance of the user third-party authentication credentials by the one or more third-party enterprise servers 400ₙ, 400ₙ₊₁, the authentication engine 223 automatically transmits an API call to the account aggregation API 600 requesting the desired action to be performed by the account aggregation API 600 (e.g., external user account data to be scraped/extracted). The external user account data may include, but is not limited to, checking account balances, savings account balances, credit card balances, investment account balances, etc. that are maintained by the one or more third-party enterprises.

The sensor engine 240 is operable, at least after launching of the mobile application by the client device 100, to dynamically detect, determine, assess, monitor, measure, quantify, and/or sense information about the client device 100. The sensor module 240 may be operable to detect, determine, assess, monitor, measure, quantify and/or sense in real-time. The sensor engine 240 may be operable to detect, determine, assess, monitor, measure, quantify, and/or sense geographic location information about the geographic location of the client device 100.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth, described, and/or illustrated herein, the client device 100 and the one or more host enterprise servers 200 could function in a fully virtualized environment. A virtual machine is where all hardware is virtual and operation is run over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment.

For example, a virtual hard disk can store the operating system, data, and application files for a virtual machine. Virtualized computer system includes computing device or physical hardware platform, virtualization software running on hardware platform, and one or more virtual machines running on hardware platform by way of virtualization software. Virtualization software is therefore logically interposed between the physical hardware of hardware platform and guest system software running “in” virtual machine. Memory of the hardware platform may store virtualization software and guest system software running in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

Any apparatus, computing device, computer program product, and computer-implemented method described herein may be at least partially processor-implemented, the one or more processors 210 being an example of hardware. For example, at least some of the operations of a method may be performed by one or more processors 210 or processor-implemented modules or engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., API 500 and account aggregation API 600).

The performance of certain of the operations may be distributed among the one or more processors 210, not only residing within a single machine, but deployed across a plurality of machines. In some example embodiments, the one or more processors 210 or processor-implemented modules or engines may be located in a single geographic location (e.g., within a home environment, an office environment, or a server farm). In other example embodiments, the one or more processors or processor-implemented modules or engines may be distributed across a plurality of geographic locations.

In accordance with one or more embodiments set forth, described, and/or illustrated herein, a user may, via the I/O hub 130a, 130b, launch or initialize execution of a host enterprise mobile application over the communication network 300 for the purpose of registering a user profile. The user may already have one or more internal user accounts that are maintained by the host enterprise, or otherwise seek to open one or more new accounts with the host enterprise.

The computer-executable program code of the one or more enterprise mobile applications of the enterprise mobile application engine 222 may instruct the one or more processors 210 to execute certain logic, data-processing, and data-storing functions of the one or more host enterprise servers 200, in addition to certain communication functions of the one or more host enterprise servers 200. The one or more enterprise mobile applications of the host enterprise mobile application engine 222 are operable to communicate with the client device 100 in a manner which facilitates user access to the one or more user accounts in addition to user management of the one or more internal user accounts based on successful user authentication.

The one or more host enterprise servers 200 are operable to access the data associated with the external user accounts that are maintained at the one or more third-party enterprises (e.g., via the one or more third-party enterprise servers 400n, 400n+1). In one example, the one or more host enterprise servers 200 may serve as a proxy for the user by utilizing the authentication credentials of the user to retrieve all data related to the external user accounts. The one or more host enterprise servers 200 may also issue commands to the one or more third-party enterprise servers 400n, 400n+1 as if the one or more host enterprise servers 200 were the user.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth and described herein, a user can have accounts that are maintained at one or more different enterprises. A user can, via an authenticated client device 100 (e.g., mobile device 100a, laptop or personal computer 100b, etc.) access internal user account data related to an account maintained by the enterprise at the one or more host enterprise servers 200 in at least two ways. Firstly, by using the mobile device 100a and launching the host enterprise mobile application software or host enterprise desktop application software (“desktop app”) to access the one or more host enterprise servers 200. Secondly, by using an enterprise web browser launched on the personal computing device 100b to access the one or more host enterprise servers 200. The one or more host enterprise servers 200 can render or generate a GUI on the UI 131a, 131b of the client device 100 that displays the internal user account data (e.g., account balance, transaction history, bill pay, etc.).

The one or more host enterprise servers 200 can also cause the GUI to display external user account data associated with one or more third-party enterprises. The one or more host enterprise servers 200, having access (e.g., stored in the memory 220) to the user authentication credentials (for the one or more host enterprise servers and the third-party enterprises), can access the external user account data, retrieve/capture/acquire the external user account data, and then cause the display of the same via the GUI. The one or more host enterprise servers 200 can aggregate the internal user account data and the external user account data as aggregated user account data for visual display on the UI 131a, 131b.

In accordance with one or more embodiments set forth and described herein, the server computing system provides a platform that enables a user to selectively view the aggregated user account data when the client device 100 has launched the host enterprise mobile application or the host enterprise desktop website. The server computing system also enables a user to make inter-account funds transfer between internal user account(s) and external user account(s).

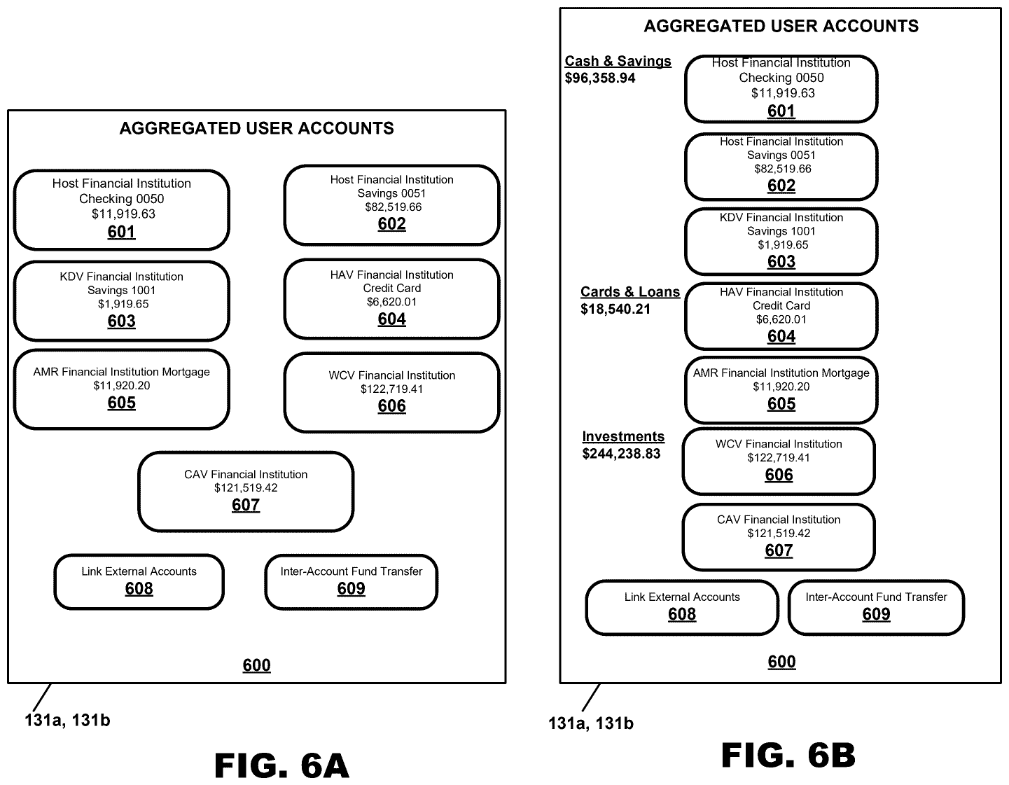

As illustrated in FIGS. 6A and 6B, an adaptive GUI 600 comprising a dashboard for visual display on the UI 131a, 131b of FIG. 5 is set forth in accordance with one or more embodiments set forth and described herein. The dashboard is presented on the interface 131a, 131b and provides the user (who is signed into the dashboard) a number of options to navigate the interface 131a, 131b so the user can obtain desired information or perform desired functions.

In the illustrated example of FIG. 6A, the adaptive GUI 600 is caused to display a plurality of user-engageable widgets 601-607 in a random arrangement or configuration.

The host enterprise is an enterprise supporting the one or more host enterprise servers 200 which provides the GUI 600 and to which the user is authenticated using authentication credentials. The one or more host enterprise servers 200 also support, distribute, and update, via the host enterprise mobile application engine 222, the host enterprise mobile application software or desktop application software associated with the enterprise. The one or more host enterprise mobile application software or desktop application software can be downloaded and launched on the client device 100, which provides the user all of the functionality (e.g., display balances for accounts maintained by the one or more host enterprise servers, enable fund transfers, bill payments, tec.) described herein.

The one or more user-engageable widgets 601, 602 visually display internal user account data that is associated with internal user accounts maintained by the one or more host enterprise servers 200, and one or more user-engageable widgets 603-607 that visually display external user account data that is associated with external user accounts maintained by the one or more third-party enterprises.

In the illustrated example of FIG. 6B, the adaptive GUI 600 is caused to display the plurality of user-engageable widgets 601-607 in an arrangement based on an assigned classification of the type of user account. The adaptive GUI 600 can be caused to rearrange the randomly displayed user-engageable widgets 601-607 based on the assigned classification. For example, one or more widgets user-engageable 601-603 associated with cash and savings accounts may be aggregated together in one group, one or more user-engageable widgets 604, 605 associated with credit cards and loans may be aggregated together in a second group, and one or more user-engageable widgets 606, 607 associated with investment accounts may be aggregated together in a third group.

The widgets user-engageable 601-607 may be user-engageable for manipulation by the user. For example, the user can manipulate (e.g., drag and drop) the user-engageable widgets 601-607 in order to rearrange the order of the user-engageable widgets 601-607. The user can also manipulate (e.g., touching, pointing, clicking, etc.) the user-engageable widgets 601-607 in order to access additional user data (e.g., transaction history, etc.) and functionality with regard to the user data.

After launching of the host enterprise mobile application software or desktop application software associated with the one or more host enterprise servers by the client device 100, a user may, via widget 608, manually add or link external user accounts, i.e., user accounts that are maintained by third-party enterprises for display on the UI 131a, 131b. The user may also manually unlink external accounts via the host enterprise mobile application software or desktop application software. A user may also, via widget 608, initiate an inter-account funds transfer between the one or more user accounts maintained by the one or more host enterprise servers 200 and the one or more external user accounts maintained by the third-party enterprises.

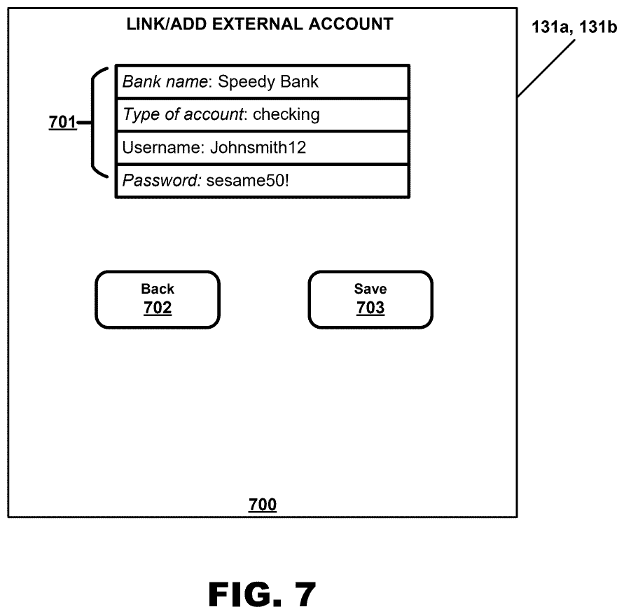

As illustrated in FIG. 7, in response to a user engaging widget 608, the computer-executable program code may instruct the one or more processors 210 to cause the display of a GUI 700 on the UI 131a, 131b. The GUI 700 includes a plurality of widgets 701-703 to facilitate the linking or addition of an external account maintained by a third-party enterprise, in accordance with one or more embodiments set forth and described herein. The widget 701 includes one or more input fields that enable the user to populate with data associated with the external account. The data include, but is not limited to, the name of the third-party enterprise, the type of user account, username, password, and any other data (e.g., user authentication credentials) that will enable the one or more host enterprise servers 200 to access the data associated with the external user accounts. The one or more host enterprise servers 200 are operable to serve as a proxy for the client device 100 by authenticating into the third-party enterprise servers 400 using the user authentication credentials. The one or more host enterprise servers 200 are operable to transmit an API call to scrape the third party user data. The scraped user data can include, but is not limited to, user account balances at the third-party enterprise (associated with the third-party enterprise servers 400), user transaction history (e.g., all individual transactions including the name of the payee, the monetary amount, transaction date, etc.), and any other data that is made available by the third-party enterprise severs 400 when a user authenticates into a user account. All of the data retrieved or acquired from the third-party enterprise servers 400 can be stored in the memory 200 and associated with the one or more internal user accounts of the user that are maintained by the one or more host enterprise servers 200. The one or more host enterprise servers 200 may periodically (e.g., daily, weekly, biweekly, etc.) and automatically authenticate into the third-party enterprise mobile application or website to access and acquired updated data.

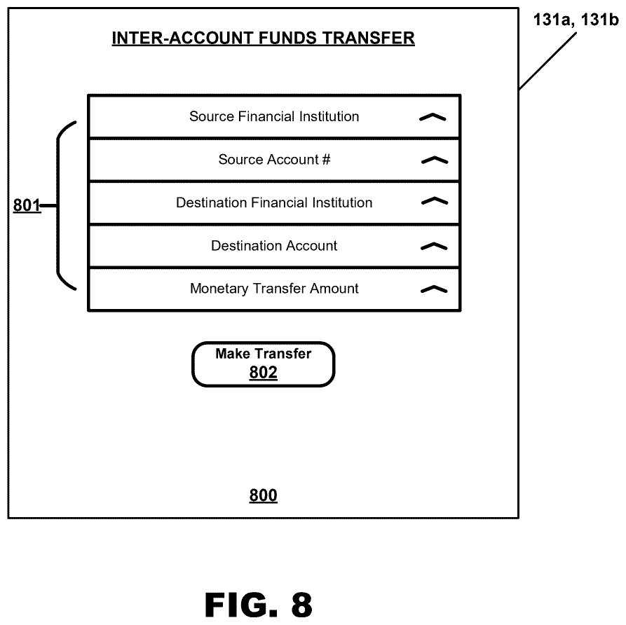

As illustrated in FIG. 8, in response to a user engaging widget 609, the computer-executable program code may instruct the one or more processors 210 to cause a display of a GUI 800 on the UI 131a, 131b. The GUI 800 includes a plurality of widgets 801 having an arrowhead that allows the user to populate input fields with instructions necessary to execute an inter-account funds transfer. The instructions include, but is not limited to, the source enterprise, the source account number associated with the source enterprise, the destination enterprise, the destination account number associated with the destination enterprise, and the monetary amount to transfer. Any additional information needed to execute the inter-account funds transfer can be requested as well (e.g., routing numbers, SWIFT codes, etc.).

In response to the user engaging widget 802, the computer-executable program code may instruct the one or more processors 210 to cause the inter-account funds transfer between the one or more internal user accounts maintained by the enterprise and the one or more external user accounts maintained by the third-party enterprises. Accordingly, the one or more host enterprise servers 200 can execute, in response to a user request, an inter-account fund transfer between the enterprise and an external user account maintained by a third-party enterprise. Additionally, the one or more host enterprise servers 200 can execute, in response to a user request, an inter-account fund transfer between external user accounts maintained by two third-party enterprises.

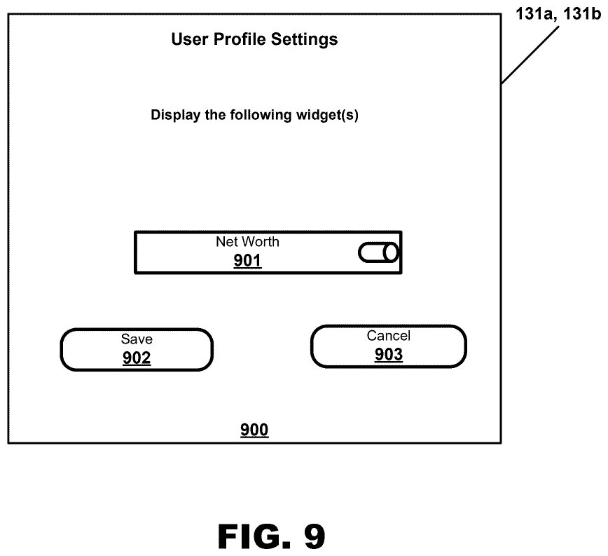

As illustrated in FIG. 9, the computer-executable program code may instruct the one or more processors 210 to cause a display of a GUI 900 on the UI 131a, 131b. The GUI 900 comprises a profile settings dashboard that includes one or more widgets 901 having a user-engageable toggle switch to selectively enable or disable the preview of a current financial net worth of the user. In response to the user manipulating the toggle-switch to an enable-position (i.e., towards the right) and engaging a widget 902 to save the setting, the computer-executable program code may instruct the one or more processors 210 to execute a calculation of the current financial net worth based on the previewed account balances (on adaptive GUI 600 of FIG. 6) of the one or more internal user accounts maintained by the enterprise and the account balances of the external user accounts maintained by one or more third-party enterprises. The computer-executable program code may instruct the one or more processors 210 to execute other calculations, including, a change in financial net worth of the user over a defined time period, a change in assets of the user over a defined time period, and a change in liabilities of the user over a defined time period.

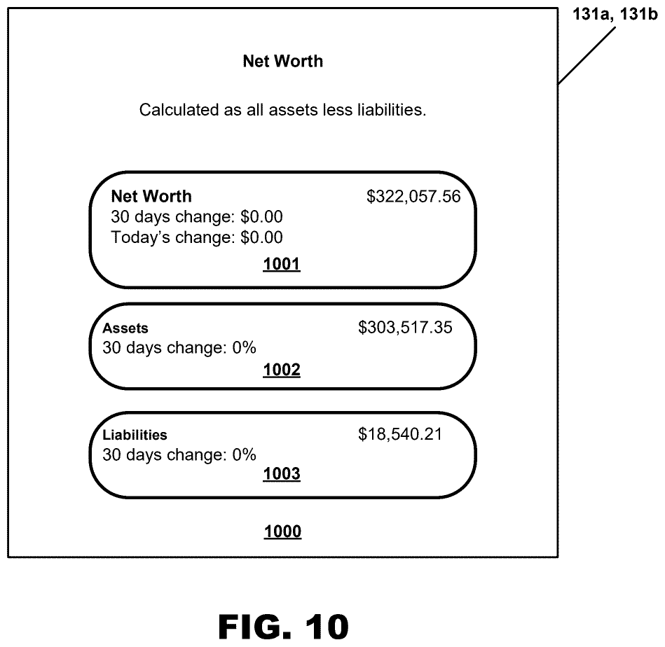

As illustrated in FIG. 10, the computer-executable program code may instruct the one or more processors 210 to cause a display of a GUI 1000 on the UI 131a, 131b. The GUI 1000 comprises one or more widgets, including a widget 1001 which visually displays the calculated current financial net worth of the user, a widget 1002 which visually displays the current assets of the user, and a widget 1003 which visually displays the current liabilities of the user. This disclosure contemplates the widgets 1001-1003 may include other data, including, but not limited to the calculated change in financial net worth of the user over a defined time period, the calculated change in assets of the user over a defined time period, and the calculated change in liabilities of the user over a defined time period.

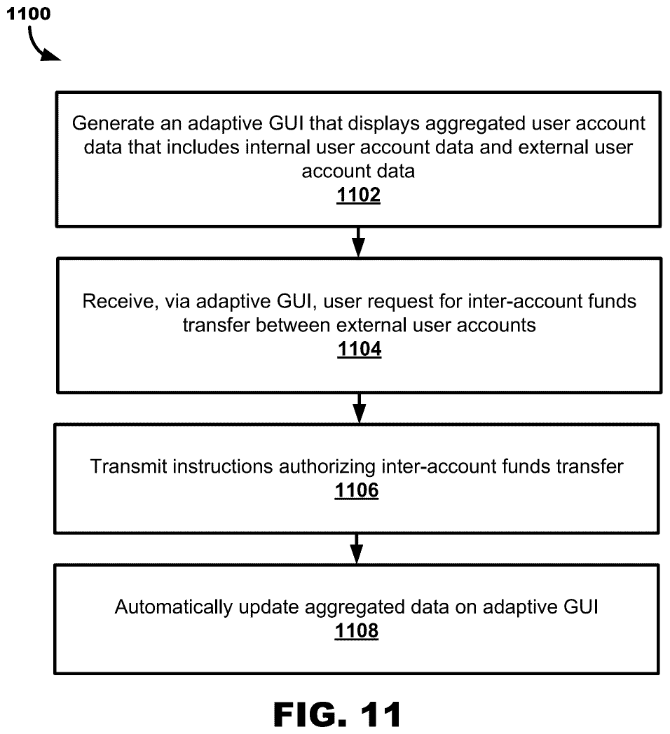

Illustrated examples shown in FIGS. 11 through 16 set forth methods 1100 through 1500. In one or more examples, the respective flowcharts of the methods 1100 through 1500 may be implemented by the one or more processors 210 of the one or more enterprise servers 200. In particular, the methods 1100 through 1500 may be implemented as one or more engines or modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, a report generating software platform launched/executed by the one or more enterprise servers 200 provides functionality described or illustrated herein. In particular, report generating software platform launched/executed by the one or more processors 210 is operable to perform one or more processing blocks of the methods 1100 and 1200 set forth, described, and/or illustrated herein, or provides functionality set forth, described, and/or illustrated.

As illustrated in FIG. 11, the method 1100 may facilitate, after generating an adaptive GUI on a user interface (UI) of an authenticated client device to display aggregated data, an inter-account funds transfer between external user accounts that are maintained by different third-party enterprises. In the illustrated embodiment, a source user account is maintained by a first third-party enterprise, and a destination user account is maintained by a second third-party enterprise.

As illustrated in process block 1102, a method 1100 includes generating an adaptive GUI on a user interface (UI) of an authenticated client device to display aggregated data that includes internal user account data and external user account data from a plurality of third-party enterprises.

From illustrated process block 1102, the method 1100 proceeds to illustrated process block 1104, which includes receiving, from the authenticated client device via the adaptive GUI, a request for an inter-account transfer between external user accounts. In accordance illustrated process block 1102, the request can include data comprising the source user account for the inter-account funds transfer, the destination user account for the inter-account funds transfer, the monetary amount to be transferred, and the date the inter-account funds transfer should be implemented.

From illustrated process block 1104, the method 1100 proceeds to illustrated process block 1106, which includes transmitting instructions for the inter-account funds transfer, as a proxy for the user, to the third-party enterprise that maintains the source user account on behalf of the user. The request can be made by causing the auto-population of the data at a website administered by the third-party enterprise that maintains the source user account. In addition, the one or more host enterprise servers may cause the transmission of a secure, encrypted data file containing a set of instructions to be executed (e.g., steps to transfer the monetary funds) by the third-party enterprise server to complete the inter-account funds transfer.

The monetary funds for inter-account funds transfer can be transferred in a number of ways, including, but not limited to, a ZELLE transfer, a wire transfer, an ACH transfer, etc. The one or more host enterprise servers would store and maintain all of the user account data for all user accounts (e.g., email addresses, passwords, authentication credentials, account numbers, routing numbers, etc.) necessary to execute the inter-account funds transfer.

From illustrated process block 1106, the method 1100 proceeds to illustrated process block 1108, which includes automatically updating, in response to confirmation of receipt of the inter-account transfer, the adaptive GUI to reflect the inter-account funds transfer.

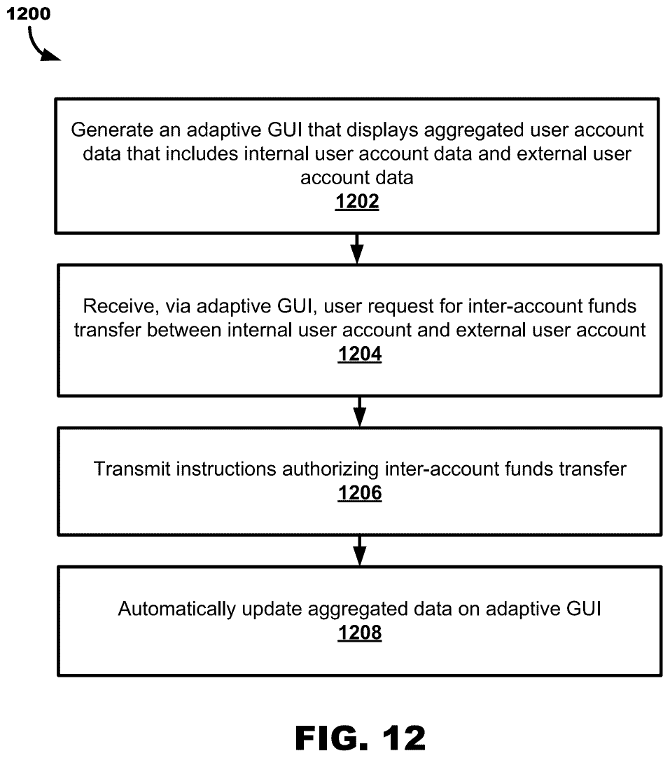

As illustrated in FIG. 12, a method 1200 may facilitate, after generating an adaptive GUI on a user interface (UI) of an authenticated client device to display aggregated data, an inter-account funds transfer between an internal user account that is maintained by the host enterprise and an external user account that is maintained by a third-party enterprise. In the illustrated embodiment, the source user account is maintained by the host enterprise, and the destination user account is maintained by the third-party enterprise.

As illustrated in process block 1202, the method 1200 includes generating an adaptive GUI on a user interface (UI) of an authenticated client device to display aggregated data that includes internal user account data and external user account data from a plurality of third-party enterprises.

From illustrated process block 1202, the method 1200 proceeds to illustrated process block 1204, which includes receiving, from the authenticated client device via the adaptive GUI, a request for an inter-account transfer between an internal user account and an external user account. In accordance illustrated process block 1102, the request can include data comprising the source user account for the inter-account funds transfer, the destination user account for the inter-account funds transfer, the monetary amount to be transferred, and the date the inter-account funds transfer should be implemented.

From illustrated process block 1204, the method 1200 proceeds to illustrated process block 1206, which includes transmitting instructions for the inter-account funds transfer, as a proxy for the user, to the third-party enterprise that maintains the source user account on behalf of the user. The request can be made by causing the auto-population of the data at a website administered by the third-party enterprise that maintains the source user account. In addition, the one or more host enterprise servers may cause the transmission of a secure, encrypted data file containing a set of instructions to be executed (e.g., steps to transfer the monetary funds) by the third-party enterprise server to complete the inter-account funds transfer.

The monetary funds for inter-account funds transfer can be transferred in a number of ways, including, but not limited to, a ZELLE transfer, a wire transfer, an ACH transfer, etc. The one or more host enterprise servers would store and maintain all of the user account data for all user accounts (e.g., email addresses, passwords, authentication credentials, account numbers, routing numbers, etc.) necessary to execute the inter-account funds transfer.

From illustrated process block 1206, the method 1200 proceeds to illustrated process block 1208, which includes automatically updating, in response to confirmation of receipt of the inter-account transfer, the adaptive GUI to reflect the inter-account funds transfer.

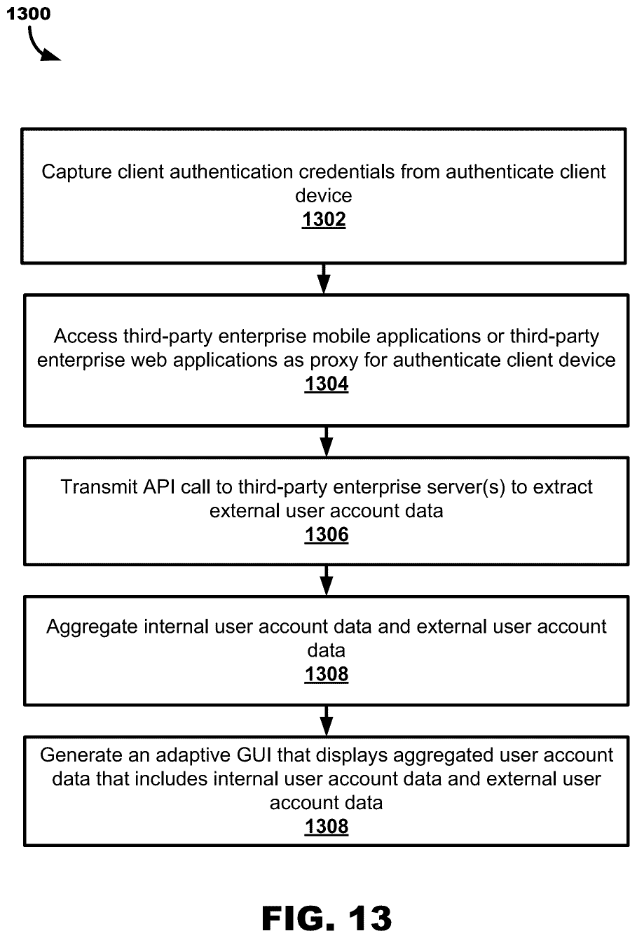

As illustrated in FIG. 13, a method 1300 includes illustrated process block 1302, which includes capturing client device authentication credentials from an authenticated client device of a user.

From illustrated process block 1302, the method 1300 proceeds to illustrated process block 1304, which includes accessing, as a proxy for the authenticated client device using the captured client device authentication credentials, third-party enterprise mobile applications or third-party enterprise web applications.

From illustrated process block 1304, the method 1300 proceeds to illustrated process block 1306, which includes transmitting an application programming interface (API) call to a third-party enterprise servers to extract external user account data from the third-party enterprise mobile application or the third-party enterprise web application, the API call including an identify token, the external user account data associated with one or more external user accounts maintained by one or more third-party enterprises.

From illustrated process block 1306, the method 1300 proceeds to illustrated process block 1308, which includes aggregating the external user account data with internal user account data associated with one or more internal user accounts maintained by the enterprise as aggregated data.

From illustrated process block 1308, the method 1300 proceeds to illustrated process block 1310, which includes generating an adaptive graphical user interface (GUI) on a user interface (UI) of the authenticated client device to display the aggregated data.

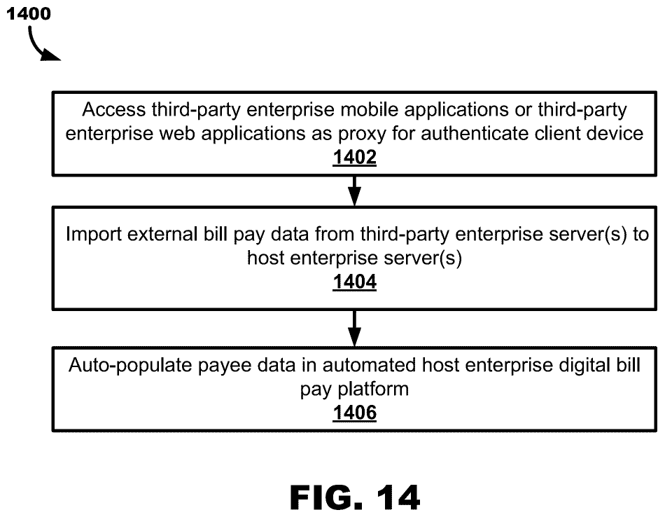

As illustrated in FIG. 14, a method 1400 may facilitate, after generating an adaptive GUI on a user interface (UI) of an authenticated client device to display aggregated data, the import of payee data in an automated third-party enterprise digital bill pay platform to an automated host enterprise digital bill pay platform. Accordingly, a user may augment payee data associated with the automated host enterprise digital bill pay platform with payee data associated with the automated third-party enterprise digital bill pay platform. This enables the user to make a payment, using the enterprise mobile application software or desktop application, to payees in the automated third-party enterprise digital bill pay platform and the automated host enterprise digital bill pay platform.

As illustrated in process block 1402, the method 1400 includes accessing, as a proxy for the authenticated client device using the captured client device authentication credentials, third-party enterprise mobile applications or third-party enterprise web applications.

In accordance with process block 1402, the enterprise server computers may access external bill pay data associated with a third-party enterprise, the external bill pay data including payee data associated with the automated third-party enterprise digital bill pay platform.

In accordance with process block 1402, accessing the access external bill pay data comprises causing an automated bot or file exchange protocol to access the access external bill pay data.

From illustrated process block 1402, the method 1400 proceeds to illustrated process block 1404, which includes importing the external bill pay data from the one or more third-party enterprise servers to the one or more host enterprise servers.

From illustrated process block 1404, the method 1400 proceeds to illustrated process block 1406, which includes auto-populating the payee data in an automated host enterprise digital bill pay platform administered by the one or more host enterprise servers.

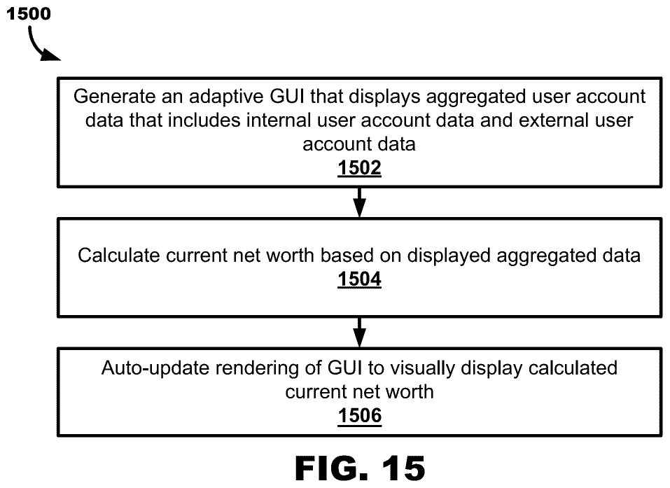

As illustrated in FIG. 15, a method 1500 may facilitate, after generating an adaptive GUI on a user interface (UI) of an authenticated client device to display aggregated data, an automatic calculation of a current net worth of the user based on assets and liabilities associated with balances displayed on the adaptive GUI.

As illustrated in process block 1502, the method 1500 includes generating an adaptive GUI on a user interface (UI) of an authenticated client device to display aggregated data that includes internal user account data and external user account data from a plurality of third-party enterprises.

From illustrated process block 1502, the method 1500 proceeds to illustrated process block 1504, which includes calculating a current net worth of the user based on the assets and liabilities associated with the displayed aggregated data.

From illustrated process block 1504, the method 1500 proceeds to illustrated process block 1506, which includes auto-updating the adaptive GUI to visually display the calculated net worth.

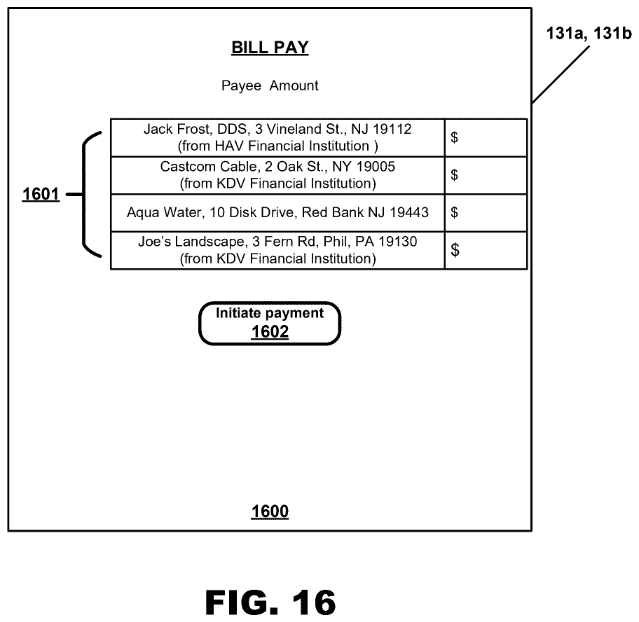

As illustrated in FIG. 16, the computer-executable program code may instruct the one or more processors 210 to cause a display of a GUI 1600 on the user interface 131a, 131b. The GUI 1600 comprises one or more widgets, including a widget 1601 which visually displays the payee data associated with the host bill pay management platform and the payee data imported from the third-party digital bill pay platform in accordance with the method of FIG. 14. The widget 1601 includes an input field to enable the user to specify a monetary amount to pay to payee. This disclosure contemplates the widget 1601 including an input field to enable the user to specific a date of execution of the payment. A user-engageable widget 1602 is provided to initiate payment, which is stored in the memory 220. Accordingly, the digital management platform enables a user to import payee data from the third-party digital bill pay platform for addition to the host digital platform. In that way, a digital management platform enables a single bill pay platform to management bill payments management associated with a host enterprise and third-party enterprise.

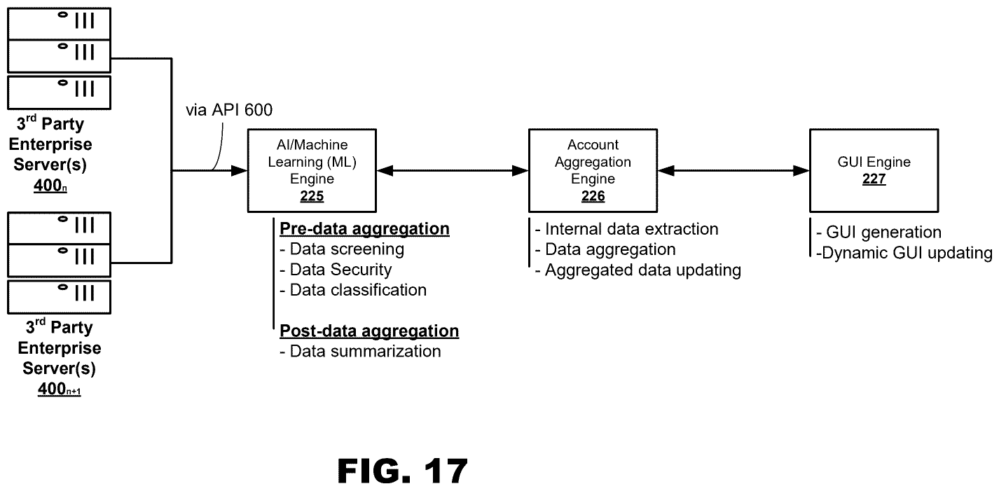

As illustrated in FIG. 17, a workflow configuration for data aggregation from a plurality of heterogenous sources is provided. The external user account data that is extracted from each third-party enterprise servers among the one or more third-party enterprise servers 400ₙ, 400ₙ₊₁ is received by the AI/ML engine 225. The AI/ML engine 225 is operable to execute one or more pre-data aggregation routines. For instance, the computer-executable program code may instruct the one or more processors 210 to cause the AI/ML engine 225 to conduct preliminary screening and/or sanitizing of the external user account data before extraction. This advantageously accelerates the processing of the external user account data while also maintaining data accuracy. To ensure the quality of the data, the computer-executable program code may instruct the one or more processors 210 to cause the AI/ML engine 225 to perform data curation by verifying the accuracy of the external user account data. Moreover, due to the likelihood of the third-party enterprise use of heterogeneous source data structures across different platforms, the computer-executable program code may instruct the one or more processors 210 to cause the AI/ML engine 225 to apply a trained ML model to identify each type of source data structure. Should it be determined that the identified source data structure is incompatible to the account structure used by the host enterprise, a trained ML model may be caused to reformat the incompatible account structure in order that it may be aggregated with the internal user account data and other external user account data.

To prevent exposure of the system to malicious activity, the computer-executable program code may instruct the one or more processors 210 to cause the AI/ML engine 225 (via a trained ML model) to detect or identify code embedded within files and/or source data structures (that contain the external user account data) that exhibit characteristics of malicious (malware) activity. In response to the detection or identification, the AI/ML engine 225 may autonomously execute one or more dedicated security routines to mitigate or eliminate malicious (malware) activity. The file and/or source data structure suspected to having the detected code is automatically extracted and isolated by transferring the file and/or source data structure to a dedicated quarantine region of the hard drive. The quarantined file and/or source data structure may undergo testing to confirm existence of malicious code. Upon confirmation of the existence of malicious code, the file and/or source data structure may be deleted. Alternatively, the quarantined malicious code may be subsequently used as training data to enhance detection of malicious code. For instance, a ML model could be trained using the training data to detect future instances of malicious code by detecting patterns and/or characteristics associated with malicious activity. All external user account data that has been screened may then autonomously assign a classification based on a plurality of different classifications. further including deploying a trained ML model to classify the user-engageable widgets based on account type (e.g., cash account, checking account, investment account, loans, savings accounts, credit card account, retirement accounts, etc.

The AI/ML engine 225 may then transfer (or be caused to transfer) the now screened and categorized external user account data to the account aggregation engine 226. The computer-executable program code may instruct the one or more processors 210 to cause the account aggregation engine 226 to extract the internal user account data from a storage location (e.g., data stores 221 and/or database 700), where it is then aggregated with the screened and categorized external user account data as aggregated data. To ensure the quality of the data, the account aggregation engine 226 is operable to dynamically update the internal user account data and the external user account data, and organize the data in a specified format (e.g., generating data structures), etc.

The account aggregation engine 226 may then transfer (or be caused to transfer) the aggregated data to the GUI engine 227, which then generates an adaptive GUI for transmission to the client device 100 for display on the UI 131a, 131b. The GUI engine 227 is operable to capture the aggregated data from the account aggregation engine 226, and then generate one or more GUIs (e.g., adaptive GUI 600) for display on the UI 131a, 131b. The GUI engine 227 is further operable to perform dynamic updates to a generated GUI that is rendered/displayed on the UI 131a, 131b. The GUI engine 227 may be given instructions to randomly arrange the aggregated data. Alternatively or additionally, the GUI engine 227 may cause the adaptative GUI to rearrange the randomly displayed aggregated data based on the assigned classification.

The AI/ML engine 225 is also operable to execute one or more post-data aggregation routines. For instance, the computer-executable program code may instruct the one or more processors 210 to cause the AI/ML engine 225 to autonomously summarize the aggregated data and also identify any errors in the aggregated data.

In accordance with one or more embodiments set forth, described, and/or illustrated herein, software executed by the one or more host enterprise servers 200 provides functionality described or illustrated herein.

Devices that are described as in “communication” with each other or “coupled” to each other need not be in continuous communication with each other or in direct physical contact, unless expressly specified otherwise. On the contrary, such devices need only transmit to each other as necessary or desirable and may actually refrain from exchanging data most of the time. For example, a machine in communication with or coupled with another machine via the Internet may not transmit data to the other machine for long period of time (e.g., weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in question, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

All records and data described herein can be stored on any type of (non-transitory) computer readable storage medium, including hard disk, solid-state drive, flash memory, etc. The data can be stored in a database using any type of indexing and querying language, such as SQL, etc.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An enterprise server computing system, comprising:
a host enterprise mobile application engine having one or more processors and a non-transitory memory coupled to the one or more processors, the non-transitory memory including a set of executable instructions of computer-executable program code, which when executed by the one or more processors, cause the one or more processors to perform operations including:
capturing client device authentication credentials from an authenticated client device of a user,
accessing, as a proxy for the authenticated client device using the captured client device authentication credentials, third-party enterprise mobile applications or third-party enterprise web applications,
transmitting an application programming interface (API) call to a third-party enterprise servers to extract external user account data from the third-party enterprise mobile application or the third-party enterprise web application, the API call including an identify token, the external user account data associated with one or more external user accounts maintained by one or more third-party enterprises,
aggregating the external user account data with internal user account data associated with one or more internal user accounts maintained by the enterprise as aggregated data, and
generating an adaptive graphical user interface (GUI) on a user interface (UI) of the authenticated client device to display the aggregated data.

2. The server computing system of claim 1, wherein the set of executable instructions, which when executed by the one or more processors, causes the one or more processors to perform operations further including assigning user-engageable widgets to the internal user account data and the external user account data.

3. The server computing system of claim 2, wherein the set of executable instructions, which when executed by the one or more processors, causes the one or more processors to perform operations further including causing the adaptative GUI to display the user-engageable widgets in a random arrangement.

4. The server computing system of claim 3, wherein the set of executable instructions, which when executed by the one or more processors, causes the one or more processors to perform operations further including deploying a trained ML model to classify the user-engageable widgets based on account type.

5. The server computing system of claim 4, wherein the set of executable instructions, which when executed by the one or more processors, causes the one or more processors to perform operations further including causing the adaptative GUI to rearrange the randomly displayed user-engageable widgets based on the assigned classification.

6. The server computing system of claim 2, wherein the set of executable instructions, which when executed by the one or more processors, causes the one or more processors to perform operations further including causing the adaptative GUI to display the user-engageable widgets based on the assigned classification.

7. The server computing system of claim 1, wherein the set of executable instructions, which when executed by the one or more processors, causes the one or more processors to perform operations further including receiving, from the authenticated client device, a user request to conduct an inter-account funds transfer between the displayed one or more internal user accounts as a source account and the displayed one or more external user accounts as a destination account.

8. The server computing system of claim 7, wherein the set of executable instructions, which when executed by the one or more processors, causes the one or more processors to perform operations further including verifying that the source account has a sufficient amount of funds to cover a monetary amount associated with the inter-account funds transfer.

9. The server computing system of claim 8, wherein the set of executable instructions, which when executed by the one or more processors, causes the one or more processors to perform operations further including executing the inter-account funds transfer when it is determined that the source account has a sufficient amount of funds to cover the monetary amount.

10. The server computing system of claim 9, wherein the set of executable instructions, which when executed by the one or more processors, causes the one or more processors to perform operations further including dynamically updating the aggregated data in response to executing the inter-account funds transfer.

11. The server computing system of claim 1, wherein the set of executable instructions, which when executed by the one or more processors, causes the one or more processors to perform operations further including calculating a current net worth of the user based on the aggregated data.

12. The server computing system of claim 11, wherein the set of executable instructions, which when executed by the one or more processors, causes the one or more processors to perform operations further including generating a second adaptive GUI for on the UI of the authenticated client device to display the calculated current net worth.

13. The server computing system of claim 1, wherein the set of executable instructions, which when executed by the one or more processors, causes the one or more processors to perform operations further including generating, by the mobile application engine, a random unique identifier associated with the authenticated client device as a client device ID.

14. The server computing system of claim 13, wherein the set of instructions, which when executed by the one or more processors, cause the one or more processors to perform operations further including automatically generating an entitlement data structure associating the client device ID with client device entitlement data.

15. The server computing system of claim 14, wherein the set of instructions, which when executed by the one or more processors, cause the one or more processors to perform operations further including verifying the identity of the authenticated registered client device by mapping, via the entitlement data structure, the unauthenticated registered client device to the client device ID.

16. The server computing system of claim 10, wherein the set of executable instructions, which when executed by the one or more processors, causes the one or more processors to perform operations further including assigning an entitlement rule associated with the authenticated registered client device based on the client device entitlement data that includes the access permission.

17. The server computing system of claim 10, wherein the set of executable instructions, which when executed by the one or more processors, causes the one or more processors to perform operations further including automatically deploying the entitlement rule and transmitting the application programming interface (API) call.

18. The server computing system of claim 1, wherein the set of executable instructions, which when executed by the one or more processors, causes the one or more processors to perform operations further including receiving, from the authenticated client device during a launching of an enterprise mobile application by the authenticated registered client device, access permission to the external user account data.

19. A computer program product comprising at least one non-transitory computer readable medium having with a set of executable instructions of computer-executable program code, which when executed by one or more processors of a server computing system, causes the server computing system to perform operations including:
capturing client device authentication credentials from an authenticated client device of a user;
accessing, as a proxy for the authenticated client device using the captured client device authentication credentials, a third-party enterprise mobile application or third-party enterprise web application;
transmitting an application programming interface (API) call to a third-party enterprise servers to extract external user account data from the third-party enterprise mobile application or the third-party enterprise web application, the API call including an identify token, the external user account data associated with one or more external user accounts maintained by one or more third-party enterprises;
aggregating the external user account data with internal user account data associated with one or more internal user accounts maintained by the enterprise as aggregated data; and
generating an adaptive graphical user interface (GUI) on a user interface (UI) of the authenticated client device to display the aggregated data.

20. A method implemented by a server computing system, the method comprising:
capturing client device authentication credentials from an authenticated client device of a user;
accessing, as a proxy for the authenticated client device using the captured client device authentication credentials, a third-party enterprise mobile application or third-party enterprise web application;
transmitting an application programming interface (API) call to a third-party enterprise servers to extract external user account data from the third-party enterprise mobile application or the third-party enterprise web application, the API call including an identify token, the external user account data associated with one or more external user accounts maintained by one or more third-party enterprises;
aggregating the external user account data with internal user account data associated with one or more internal user accounts maintained by the enterprise as aggregated data; and
generating an adaptive graphical user interface (GUI) on a user interface (UI) of the authenticated client device to display the aggregated data.
